(19) United States
(12) Patent Application Publication
(10) Pub. No.: US 2007/0187314 A1
(43) Pub. Date: Aug. 16, 2007

(54) Chemical reaction

(75) Inventor: Rodney Martin Sambrook, Chesterfield (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DYTECH CORPORATION LIMITED, Sheffield (GB)

(21) Appl. No.: 10/598,129

(22) PCT Filed: Mar. 23, 2004
(86) PCT No.: PCT/GB04/01271

§ 371 Date: Aug. 18, 2006

(51) Int. Cl. B01F 3/04

(52) U.S. Cl. 210/220; 48/198.3

(57) ABSTRACT

A method of treating a process stream by catalysis, which method comprises passing the process stream through a chemical reactor containing catalytic material and including the step of passing the process stream through a layer of filter material located in the reactor, the layer comprising shaped porous bodies of ceramic material, the porosity being from about 65% to about 90%, the pores being defined by struts and windows

The invention relates to the purification of gaseous and liquid process streams and the clean up of gaseous and liquid waste streams. More particularly, but not exclusively, the invention relates to chemical reactors and in the reaction of organic substances in a feed stream passed through a chemical reactor containing a catalyst bed.

Chemical reactor beds include catalyst particles contained in fixed filter beds. Filter layers are present at the inlet and/or outlet ends to trap contaminants such as dirt, iron oxide, carbonaceous scale, iron sulphide, nickel, vanadium, asphaltenes, coke fines, catalyst fines or dust, sediments or other entrained foreign particulate material in the reactor feed stream. The trapping of the contaminants is to prevent fouling or otherwise deactivating the catalyst bed and to minimise increases in pressure drop across the reactor. Fluid flow distribution is also improved.

EP 1293246 discloses a chemical reactor which uses a reticulated ceramic material to filter the reaction stream. The reticulated material comprises an open network of ceramic struts with a preferable pore size in the region of 10 to 80 pores per linear inch (ppi) (3.93-31.50 pores per linear centimeter), relating to a pore size of from about 5590 to 700 μm.

It is an object of this invention to provide a material which will fulfill this function in a particularly efficient way.

In one aspect the invention provides a method of treating a process stream by catalysis, comprising passing the process stream through a chemical reactor containing catalytic material and including the step of passing the process stream through a layer of filter material located in the reactor, the layer comprising shaped porous bodies of ceramic material, the porosity being from about 65% to about 90%, the pores being defined by struts and walls in at least some of which windows are formed to allow fluid communication between adjacent pores.

Preferably the pore size ranges from about 30 micron to about 1500 micron. For most applications the range is about 200 to about 500 micron. Preferably, the window size (i.e. the diameter or cross-window maximum straight-line dimension) of the pores is less than 500 μm, preferably less than 450 μm, and even more preferably is in the range of from about 30 to 450 μm, say 30 to 80 μm. Clearly, the smaller the window size, the smaller the particulate to be filtered from the process stream.

The pore size and pore characteristics such as window size can be adjusted to meet particulate removal requirements of the process. Preferably the porosity exceeds 70% so that the pores are all interconnected. Preferably the density of the body ranges from about 10% to about 30% of theoretical density. Using the process of manufacture detailed below, it is possible to maintain the number or pores at higher densities by decreasing the pore size, i.e. the density may be increased by increasing the strut and wall thickness. Preferably, no solid or liquid pore formers are used to fabricate the pores in the material although in some cases such pore formers may be used.

The chemical reactors may include hydrotreater, hydrorefiner, hydrocracker, reformer, alkylation, isomerization, and polymerization reactors. The process stream may be a liquid, vapour or gaseous stream, say a waste gas stream. The particles may be contained in one or more fixed beds and in an upflow, downflow or radial flow design.

The bodies may be of different shapes such as substantially spherical-shaped balls, raschig rings, saddles, hollow cylinders, perforated disks, disks, single sheets, fluted rings and solid cylinders, among others. Each shape may be sized to individual specifications. Sizes for the shapes used may include substantially spherical balls of about 3 mm to 60 mm diameters; raschig rings with inside diameters of about 3 mm to 12 mm and outside diameters of about 8 mm to 25 mm, and heights of about 6 mm to 50 mm; saddle shapes with radii of about 6 mm to 60 mm; and solid cylinders having diameters of about 3 mm to 50 mm and heights of about 6 mm to 75 mm.

The porous bodies may be made of alumina, mullite, silicon carbide, silicon nitride, boron nitride, boron carbide, cordierite, silicas, molecular sieves, zirconia, spinels, hydroxyapatite, magnesia zinc oxide, zinc titanate, perovskites and other metal oxides, e.g. tin oxide or titanium dioxide nickel oxide, lanthanum oxide and the like. Multi-component compositions may be used.

The pore surfaces of the bodies may be coated with catalytic species prior to use, e.g. species containing a Group VI-B metal or a Group VIII metal, or both. The porous body may be wash-coated with e.g. a high surface alumina prior to the addition of the catalytic species. The species may be added by impregnation, vacuum impregnation urea deposition and other methods known to those skilled in the art. Preferably, for hydrogenation of unsaturated compounds, the Group VI-B metal is molybdenum and preferably, the Group VIII metal is either nickel or cobalt. The porous body may also be catalytically active in nature e.g. perovskites, nickel spinel or the like or which may be activated by external means e.g. photoactivation of a titanium dioxide porous body by UV for the destruction of for example of VOCs (volatile organic compounds) in gaseous streams.

The method of the present invention for filtering organic-based feed streams in chemical reactors, when compared with prior art methods, has the advantages of: reducing the volume of inert materials required; lowering capital costs; improving the filtration of the solid particular matter from the feed streams; minimizing the pressure drop across the system; increasing run time of the reactor; lowering operating costs; increasing process safety; and reducing environmental concerns.

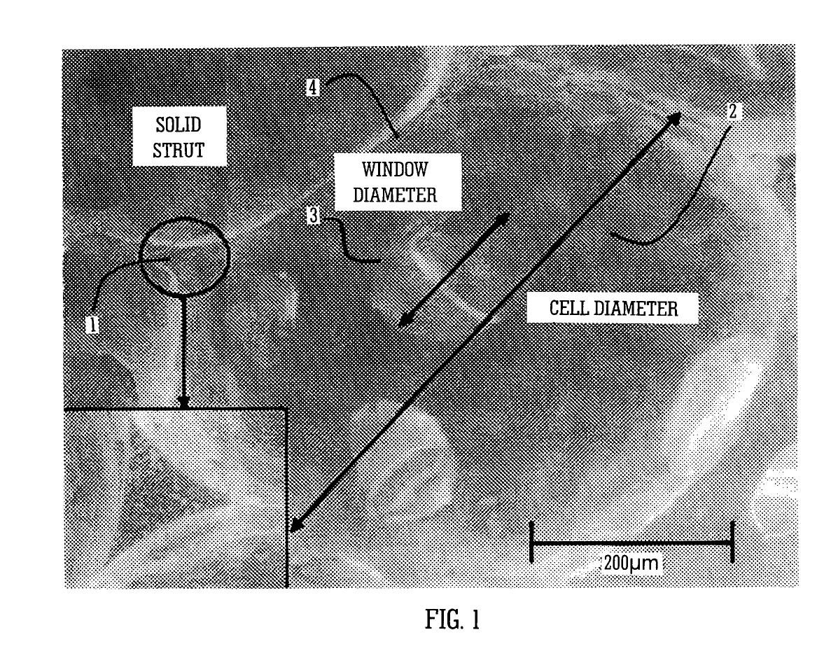

The body has interconnected pores 4 and these are defined by intervening walls 2 or partitions as shown in the magnified photograph of FIG. 1. Struts 1 are formed at the border of two or more pores 4. This is in contrast to a reticulated structure which consists essentially of a network of struts with open interconnected cells of a very narrow size distribution (where the pores are open and interconnected to form a continuous flow path.) In a body of the invention, the partitions 2 have apertures, which we call windows 3 which provide access to the adjacent pores 4. As a result the degree of filtration is high and the trapping capacity is high. The filtration efficiency can be optimised by control of the porosity, pore size and window size for a particular application.

The bodies may be made in a variety of ways. Preferably the bodies are made by a method which comprises the steps of:
a) forming a dispersion comprising particles in a liquid carrier and a binder;
b) introducing gas into the dispersion; and
c) removing the liquid carrier to provide a solid article having pores derived from the bubbles,
   wherein the dispersion has a critical viscosity selected to be below the level at which the introduction of gas cannot take place and above the level at which entrapped gas bubbles will tend to escape.

The viscosity of the dispersion will be low by which we mean that the viscosity must be less than that level at which the introduction of gas cannot take place and above the level at which entrapped gas bubbles will tend to escape. By the term “critical viscosity” is meant the corresponding viscosity at the critical stress value, see K. S. Chou, L. J. Lee, “Effects of Dispersants on the Rheological Properties and Slip Casting of concentrated Alumina Slurries”, J. Amer. Ceram. Soc.; (1989) 72 (9); pp 1622-1627.

The critical viscosity of the dispersion will be in the range of from about 5 mPa·s, to about 1000 mPa·s preferably 25 mPa·s to about 1000 mPa·s, more preferably 25 mPa·s to about 250 mPa·s. The preferred range is dependent on the method of gas entrapment. For entrapment by mechanical means e.g. stirring, the preferred range is 25 mPa·s to about 200 mpa·s. For gas entrapment by mechanical means using a filter of defined pore size, the preferred range is about 50 mPa·s to about 250 mPa·s.

The dispersion is formulated so that the dispersion is essentially colloidal in nature. The average particle size will tend to be less than about 5 μm and preferably 95% of the particles will be less than about 2 μm. If the particles are larger than this size then the particles tend to settle or sediment. However, the particles can be much larger, say 100 μm or more, in which case agents will be present to control undesired settling; polymerisation of monomers is a suitable means for preventing settling.

The content of the solids in the dispersion will tend to be about 40% by weight as a minimum and about 90% by weight as a maximum; a preferred range is from about 60% to about 85% by weight.

Conveniently the liquid carrier is water but it may be organic, e.g. an alcohol, glycol or the like; or a mixture.

Where there is a risk that the formed dispersion will tend to undergo premature settling of solids it is preferred to add agents e.g. deflocculating agents so that the dispersion will be maintained. In the case of small particles, any premature settling or sedimentation will of course tend to disrupt the colloidal nature of the dispersion; the settling can take place by agglomeration of particles over time. The agent may be a deflocculating agent the nature of which will depend on the particles and the liquid carrier; for ceramic particles in water single or multiplecomponent surfactants (non-ionic, cationic or anionic), or carbohydrates may be used. Additives which adjust pH and polymers are also suitable agents. For large or small particles polymerisable monomers may also be used.

The bubbles of gas may be introduced in any convenient way. For convenience and economy the gas is air or nitrogen.

The foaming characteristics of the dispersion may be controlled by the inclusion of a surfactant. The foam may be stabilised by the inclusion of foam builders. The addition of one substance may fulfil both roles.

A bonding or stabilising agent may be added to prevent collapse of the formed foam. It has been discovered that a deflocculating agent can fulfil this role also but any cationic, anionic or non-ionic surfactant can be considered.

Other additives may be present, e.g. liquefiers, viscosity control agents, reinforcing fibres or particles, accelerators, retarders, colourants, and the like.

The foamed composition may be allowed or caused to acquire sufficient green strength to allow it to be moved from the parent container or mould. The composition may be subjected to drying to drive off the liquid. In the case of water the drying can be carried out at below about 100° C. in an oven or using high frequency drying equipment. The drying step may be varied. For example, the drying may be done under reduced pressure to cause the foam to expand before the green strength is developed. The degree of expansion and hence the pore size of the foam will depend on the pressure selected. Drying at elevated temperature tends to cause a slight expansion of the foam. It is preferred to control the humidity during the drying step, to prevent uneven shrinkage and drying cracks, whereas if the polymerisable material is present in the dispersion this step might not need to be taken.

The dispersion may include other ingredients which play a role at the drying stage. Examples include binders such as resins, e.g. polyvinylchloride, polyvinyl acetate gums, celluloses, and polymerisable materials to increase green strength. A specific class of such additives is organic monomers such as soluble acrylates and acrylamides. The additives are preferably dissolved in deionised water or other carrier liquid or a mixture to produce a premix solution, an initiator is added to the dispersion before foaming and a catalyst after foaming. Elevated temperature can be a suitable substitute for the catalyst or both may be used together. The resultant formed body after drying is relatively robust, and this addition is especially preferred when the article to be formed is of a complex shape.

It is a feature of the invention that the final articles may consist essentially of the starting materials only, so avoiding the need for the presence of residual secondary materials, e.g. inorganic binders.

The invention also includes a method including a polymerisable monomer in the low viscosity dispersion of a particulate refractory material and water, foaming, drying and then sintering, whereby the article formed is relatively robust. The polymerisation preferably proceeds by crosslinking of reactive organic monomers. Examples include acrylates, such as ammonium acrylate or hydroxyethyl methacrylate; or the like. Preferably the monomers are dissolved in water or other liquid carrier to give a premix solution to which an initiator is added to cause free radical vinyl polymerisation to take place. Heat and/or a catalyst may be used to accelerate the process. In another variation, the dispersion includes a monosaccharide such as galactose, which can be condensed to form a dimer, trimer or polymer, to have the same effect.

In another aspect of the invention relating to the removal of contaminants from gaseous waste streams the porous ceramic bodies may be used in the typical candle filters applications for hot gas filtration. In this case the outer surface of the porous body may have a coating of a substance (which may be the same as that of which the body is formed or different) in fine particulate form and applied so that the coating has a level of porosity. Such a porous ceramic body has the advantage of providing a more uniform flow pattern through the filter candle. The flow pattern can be further improved by grading the porosity and/or pore size along the length of the filter candle.

In more specialised applications the filter material can be held in a rotating wheel or slide configuration such that only a proportion of the filter material is exposed to the waste stream at any one time and the other portions of the filter are exposed to a regenerative process or being held in a standby mode. The filter material may also be catalytic in nature or catalytic material may be incorporated within the filter material or be infiltrated, impregnated etc on the pore surfaces. Examples of an active wheel filter or slide filter may be in VOC removal from stack gases, diesel particulate filters, partial oxidation reactors for syngas production, separation of gases when the active material is a molecular sieve, drying of gases etc.

In use, the filter material of the current invention may be used in any of the chemical reactors discussed in EP 1293246 (the entire disclosure of which is herein incorporated by reference).

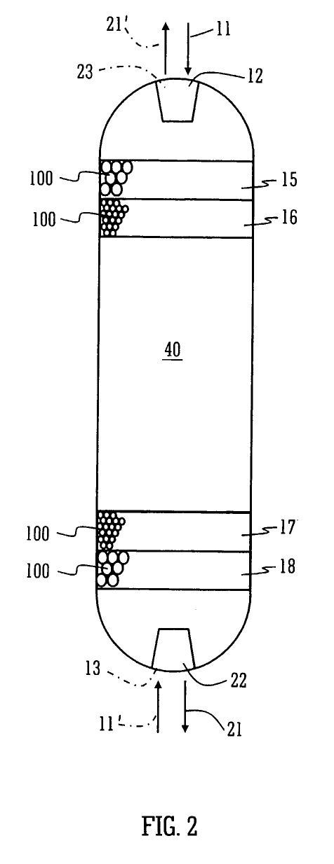

FIG. 2 shows a partial cross sectional view of a single, fixed bed chemical reactor 10 showing the filter material 100 in use.

If the reactor 10 is to be used in the ‘down flow’ configuration, a contaminated organic-based feed stream 11 will enter the reactor 10 at an inlet 12 located at the top thereof. Conversely, if the reactor 10 is to be used in an ‘up flow’ configuration, the organic-based feed stream 11′ will enter the reactor at an inlet 22 located at the bottom thereof. In either case, the outlet 13, 23 will be located at the opposite end of the reactor 10.

A layer 15 or layers 15, 16 of filter material 100 according to the invention is provided in the reactor 10 to filter the contaminants from the feed stream 11. Preferably the size of the filter media 100 is chosen so that it reduces in size in the flow direction of the feedstock. Optionally, the window size of the ceramic material 100 may also be graduated from large windows to small windows to lessen the pressure drop through the reactor attributable to filtering of the suspended solids (and optionally or usually from large pores to small pores).

As will be appreciated, the filter material 100 of FIG. 2 is shown as being formed as substantially spherical balls, although as previously discussed other shapes of the ceramic filter material 100 may be used.

The reactor 10 may include hydrotreater, hydrorefiner, hydrocracker, reformer, alkylation, isomerization and polymerization reactors 40.

Contaminants typically found in the feed stream include dirt, iron oxide, iron sulfide, asphaltenes, coke fines, catalyst fines, sediments or other entrained foreign particulate material.

The ceramic material 100 may be present in further layers 17, 18 to filter and retain catalyst 36 from an outgoing reacted organic-based stream 21. Small particles of the catalyst material which may be entrained in the reacted organic-based stream may be filtered, or captured, from the reacted organic-based stream 21 and retained by ceramic material layers 17, 18. Preferably, the size of the ceramic material in layers 17, 18 is graduated from a smaller size in layer 17 to a larger size in layer 18 at the outlet 22 of the reactor 10 to effectively retain the catalyst. In addition, sediments of material may form in the reactor bed, e.g., sediments formed by excessive hydrocracking of residual oils, that may plug or foul downstream equipment. These sediments may be filtered from the outgoing reacted organic-based stream 21 by the filter material 100.

Another advantage of the present invention is to react partially activated or activated ceramic material 100 with polymer precursors in a contaminated organic-based feed stream 11. Condensation polymerization of diolefins may occur in the reactor bed 40 after the contaminated organic-based feed stream 11 is heated, generally prior to introduction into the chemical reactor 10, thereby forming foulants in the reactor bed 40 itself which may gum or plug the bed 40. As the foulants form in the bed 40, they cannot be filtered from the contaminated organic-based feed stream before flowing across the fluid entry cross-section. Therefore, the layer or layers 15, 16, 17, 18 of ceramic material 100 may be coated with an alumina powder which may also act as a substrate for catalyst materials to form partially activated ceramic material. As used herein, an “activated support” means a ceramic material which has been impregnated with catalyst materials, or a ceramic material which may be an oxide, nitride, or carbide of a metal or a ceramic material which contains zeolite or inorganic oxides, e.g., alumina, silica, silica-alumina, magnesia, silica-magnesia or titania. As used herein, a “partially activated support” means an activated support material which has been purposefully made less active or partially deactivated in order to achieve a slower reaction rate or to partially react the materials contacted.

Coated ceramic material 100 may also be used, wherein the coating may comprise one of several conventional catalysts. Alumina may be used as an active coating, optionally but preferably, alumina may be used as a support. The catalyst according to this invention preferably comprises a metal of Group VI-B or a member of Group VIII, or both, impregnated into an alumina-based support. Accordingly, the catalyst may comprise at least one of chromium, molybdenum and tungsten in combination with at least one of iron, nickel, cobalt, platinum, palladium and iridium. Of the Group VI-B metals, molybdenum is most preferred. The catalyst preferably will contain from about 2% to about 14% by weight of Group VI-B metal. Of the Group VII metals, nickel and cobalt are most preferred. The amount of Group Vil metal in the catalyst is preferably from about 0.5% to about 10% by weight. The porous body may also be catalytically active in nature e.g. perovskites, nickel spinel or the like or which may be activated by external means e.g. photoactivation of a titanium dioxide porous body by UV for the destruction of for example of VOCs (volatile organic compounds) in gaseous streams.

1. A method of treating a process stream by catalysis, comprising passing the process stream through a chemical reactor containing catalytic material and including the step of passing the process stream through a layer of filter material located in the reactor, the layer comprising shaped porous bodies of ceramic material, the porosity being from about 65% to about 90%, the pores being defined by struts and walls in at least some of which windows are formed to allow fluid communication between adjacent pores.

2. A method according to claim 1, wherein the pore size of the pores in the porous bodies ranges from about 50 micron to about 1500 micron.

3. A method according to claim 1, wherein the window size is less than 450 μm.

4. A method according to claim 1, wherein the porosity of the porous bodies exceeds 75% so that the pores are all interconnected.

5. A method according to claim 1, wherein the density of the body ranges from about 10% to about 30% of theoretical density.

6. A method according to claim 1, wherein the pore surfaces of the bodies are coated with catalytic species prior to use.

7. A method according to claim 1, wherein the filter material is held in a rotating wheel or slide configuration such that only a proportion of the filter material is exposed to the process stream at any one time and the other portions of the filter are exposed to a regenerative process or being held in a standby mode.

8. A method of fabricating chemical reactor filter material, the material comprising porous bodies having a porosity of from 65 to 95%, the method comprising the steps of:
a) forming a dispersion comprising particles in a liquid carrier and a binder;
b) introducing gas into the dispersion; and
c) removing the liquid carrier to provide a solid article having pores derived from the bubbles,
wherein the dispersion has a critical viscosity selected to be below the level at which the introduction of gas cannot take place and above the level at which entrapped gas bubbles will tend to escape.

9. A method according to claim 8, wherein the critical viscosity of the dispersion is in the range of from about 5 mPa·s, to about 1000 mPa·s.

10. A method according to claim 8, wherein the critical viscosity of the dispersion is in the range from about 25 mPa·s to about 1000 mPa·s.

11. A chemical reactor comprising a filter material formed in accordance with the method of claim 8.

12. A chemical reactor filter material, comprising a plurality of shaped porous bodies, each body having a porosity of from 65 to 95% and comprising struts and walls, at least some of the walls having windows therein to allow fluid communication between adjacent pores.

13. A filter material according to claim 12, wherein the window size is less than 450 μm.

14. A filter material according to claim 11, wherein at least some of the surface of at least some of the porous bodies are coated with one or more catalysts.

15. A filter material according to claim 14, wherein the catalyst is photolytically activated or activatable.

16. A filter material according to claim 12, wherein at least some of the surface of at least some of the porous bodies are coated with one or more catalysts.

17. A filter material according to claim 16, wherein the catalyst is photolytically activated or activatable.
